(19) United States
(12) Patent Application Publication
(10) Pub. No.: US 2026/0254536 A1
(43) Pub. Date: Aug. 27, 2026

(54) OPTICAL COMMUNICATION SIGNAL RECEIVING DEVICE AND OPTICAL COMMUNICATION SIGNAL RECEIVING METHOD

(71) Applicant: NEC Corporation, Tokyo (JP)

(72) Inventors: Yohei HASEGAWA, Tokyo (JP); Koya Takata, Tokyo (JP)

(73) Assignee: NEC Corporation, Tokyo (JP)

(21) Appl. No.: 19/447,210

(22) Filed: Jan. 13, 2026

(30) Foreign Application Priority Data
Feb. 21, 2025 (JP) 2025-027137

(51) Int. Cl. H04B 10/67; G02B 3/00; H04B 10/69

(52) U.S. Cl. CPC H04B 10/67; G02B 3/0056; H04B 10/69

(57) ABSTRACT

An optical communication signal receiving device includes a condenser lens that collects an optical communication signal at a plurality of focal positions, a light receiving means in which a plurality of light receiving sensors are arrayed to receive the optical communication signal collected at the focal positions, and a sensor signal processing means for processing sensor signals from the light receiving sensors to acquire one or more optical communication signals.

This application is based upon and claims the benefit of priority from Japanese Patent Application No. 2025-027137, filed on Feb. 21, 2025, the disclosure of which is incorporated herein in its entirety by reference.

### TECHNICAL FIELD

The present disclosure relates to an optical communication signal receiving device and an optical communication signal receiving method.

### BACKGROUND ART

There is known an optical space communication technology that performs information communication between spatially separated positions by transmitting a high-energy light beam having strong directivity. The optical space communication is expected to be utilized in satellite communication and land communication. However, it is necessary to improve reception efficiency in the optical space communication due to communication performed in a long distance space, communication performed with a mobile body, and the like. For this purpose, it is necessary to downsize receiving devices (a light receiving sensor such as a photodiode (PD), an optical fiber, and the like), and for example, it is necessary to irradiate a very small PD with strong reception light.

### SUMMARY

For example, PTL 1 (JP 2004-96155 A) discloses a receiving optical system including an optical means for collecting a light beam sent from a counterpart device on an end surface of a bundle of optical fibers, one or more photodetectors, and the bundle of optical fibers for sending the collected light beam to the photodetector. However, there is room for improvement in terms of increasing the density of the optical fibers. In addition, as a method of increasing the reception efficiency, there is a method of arranging a plurality of PDs in an array, but there is a problem that the ratio of the PDs in the entire area is low.

The present disclosure has been made in view of the above problems, and an exemplary object thereof is to provide a reception technology capable of acquiring an optical signal even when focal position misalignment occurs in a light receiving device in which a plurality of light receiving sensors are arrayed.

An optical communication signal receiving device according to an exemplary aspect of the present disclosure includes a condenser lens that collects an optical communication signal at a plurality of focal positions, a light receiving means in which a plurality of light receiving sensors that receive the optical communication signals collected at the focal positions are arrayed, and a sensor signal processing means for processing sensor signals from the light receiving sensors to acquire one or more optical communication signals.

An optical communication signal receiving method according to an exemplary aspect of the present disclosure includes collecting an optical communication signal at a plurality of focal positions using a condenser lens, receiving the collected optical communication signal by a light receiving means in which a plurality of light receiving sensors are arrayed, and processing, by at least one processor, sensor signals from the light receiving sensors to acquire one or more optical communication signals.

According to an exemplary aspect of the present disclosure, it is possible to provide the technology capable of acquiring the optical signal even when the focal position misalignment occurs in the light receiving device in which the plurality of light receiving sensors are arrayed.

### BRIEF DESCRIPTION OF THE DRAWINGS

FIG. 1 is a block diagram illustrating a configuration of an optical communication signal receiving device according to the present disclosure;

FIG. 2 is a flowchart illustrating a flow of an optical communication signal receiving method according to the present disclosure;

FIG. 3 is a block diagram illustrating a configuration of an optical communication signal receiving device according to the present disclosure;

FIG. 4 is a schematic diagram illustrating specific configurations of a condenser lens, a light receiving unit, and a sensor signal processing unit in the present disclosure;

FIG. 5 is a schematic view illustrating sizes and arrangements of focal spots and light receiving sensors in the present disclosure;

FIG. 6 is a schematic view illustrating a positional relationship between the focal spot and the light receiving sensor in an X direction in the present disclosure;

FIG. 7 is a schematic view illustrating a degree of overlap between the focal position and the light receiving sensor in a case where an optical axis of the condenser lens is shifted in the X direction in the present disclosure;

FIG. 8 is a schematic view illustrating an incident direction of an optical signal in a state of being along an optical axis direction of the condenser lens and in a state of being shifted by an angle θ in the present disclosure;

FIG. 9 is a schematic view illustrating an overlapping state in a case where the incident direction of the optical signal is shifted from the optical axis direction of the condenser lens in the present disclosure;

FIG. 10 is a flowchart illustrating a flow of an optical communication signal receiving method according to the present disclosure; and

FIG. 11 is a configuration diagram for implementing the optical communication signal receiving device by software.

### EXAMPLE EMBODIMENT

Hereinafter, example embodiments of the present invention will be exemplified. However, the present invention is not limited to the following exemplary example embodiments, and various modifications can be made within a scope described in the claims. For example, example embodiments obtained by appropriately combining technologies (some or all of things or methods) adopted in the following exemplary example embodiments can also be included in the scope of the present invention. Example embodiments obtained by appropriately omitting some of the technologies adopted in the following exemplary example embodiments can also be included in the scope of the present invention. Effects mentioned in the following exemplary example embodiments are examples of effects expected in the exemplary example embodiments, and do not define extension of the present invention. In other words, example embodiments that do not provide the effects mentioned in each of the following exemplary example embodiments can also be included in the scope of the present invention.

### First Exemplary Example Embodiment

A first exemplary example embodiment that is an example of the example embodiments of the present invention will be described in detail with reference to the drawings. The present exemplary example embodiment is a basic form of each exemplary example embodiment to be described below. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in the drawings referred to for describing the present exemplary example embodiment can also be adopted in another exemplary example embodiment included in the present disclosure within a range in which no particular technical problem occurs.

### (Configuration of Optical Communication Signal Receiving Device)

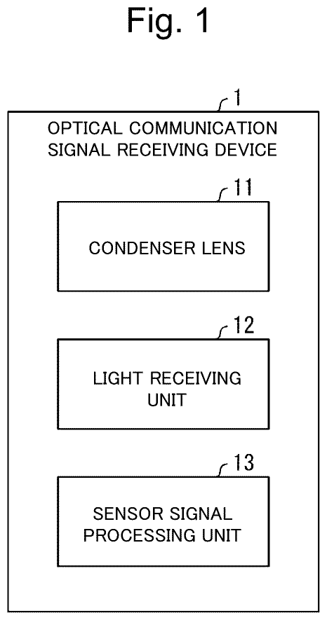

A configuration of an optical communication signal receiving device 1 will be described with reference to FIG. 1. The optical communication signal receiving device 1 (hereinafter, referred to as the “receiving device 1”) is a receiving device that receives a transmitted optical signal among optical communication devices that communicate information using optical communication signals (hereinafter referred to as “optical signals”). FIG. 1 is a block diagram illustrating a configuration of the receiving device 1. As illustrated in FIG. 1, the receiving device 1 includes a condenser lens 11, a light receiving unit 12, and a sensor signal processing unit 13.

The condenser lens 11 collects the received optical signal at a plurality of focal positions. For example, a microlens array may be used as the condenser lens 11 for collecting the optical signal at the plurality of focal positions.

The microlens array is a lens in which a plurality of condensing microlenses are arranged at predetermined positions. One condensing microlens collects the optical signal to one focal position. That is, the condenser lens 11 only needs to have a function of dividing the optical signal and collecting the divided optical signals.

In the light receiving unit (light receiving means) 12, a plurality of light receiving sensors are arrayed in such a way as to receive the optical communication signals condensed at the focal positions. That is, the light receiving sensors of the light receiving unit 12 are arranged in such a way that the plurality of microlenses collects the optical signals, respectively. However, not all the light receiving sensors necessarily receive all the collected optical signals at the same time. Examples of the light receiving sensor include a photodiode (PD) that converts light into a sensor signal (electric signal). The condenser lens 11 and the light receiving unit 12 are also collectively referred to as a light receiving device.

The sensor signal processing unit 13 processes sensor signals from the light receiving sensors to acquire one or more optical communication signals. More specifically, the sensor signal processing unit 13 combines electrical signals from one or more PDs to acquire the optical communication signal as one or more pieces of received data. The sensor signal processing unit 13 may process the same signal acquired by each of the plurality of light receiving sensors or a partial signal thereof. In such a case, one common optical communication signal among a plurality of signals may be combined.

### (Effect of Optical Communication Signal Receiving Device)

As described above, the optical communication signal receiving device 1 adopts a configuration including the condenser lens 11 that collects the received optical communication signal at the plurality of focal positions, the light receiving unit 12 in which the plurality of light receiving sensors that receive the optical communication signal collected at the focal positions are arrayed, and the sensor signal processing unit 13 that processes the sensor signals from the light receiving sensors to acquire the one or more communication signals. Therefore, according to the optical communication signal receiving device 1, it is possible to obtain an effect that the optical signal can be acquired even when focal position misalignment occurs in a light receiving device in which the plurality of light receiving sensors are arrayed.

### (Flow of Optical Communication Signal Receiving Method)

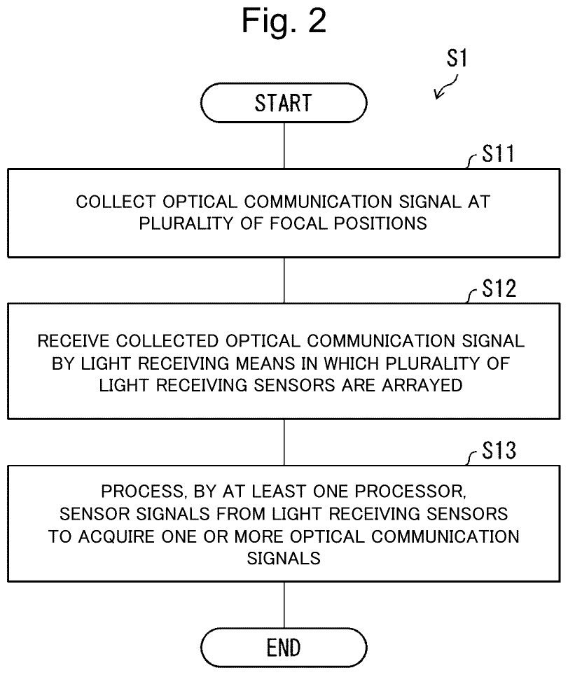

A flow of an optical communication signal receiving method S1 will be described with reference to FIG. 2. FIG. 2 is a flowchart illustrating a flow of the optical communication signal receiving method S1. As illustrated in FIG. 2, the optical communication signal receiving method S1 includes a light collection process S11 of collecting an optical communication signal at a plurality of focal positions using a condenser lens, a light reception process S12 of receiving the collected optical communication signal by a light receiving means in which a plurality of light receiving sensors are arrayed, and an acquisition process S13 of processing sensor signals from the light receiving sensors by at least one processor to acquire one or more communication signals. The light collection process S11 is performed by the condenser lens 11 described above. The light reception process S12 is executed by the light receiving unit 12 described above. The acquisition process S13 is executed by the above-described sensor signal processing unit (processor) 13.

### (Effect of Optical Communication Signal Receiving Method)

As described above, a configuration is adopted in which the optical communication signal receiving method S1 includes the light collection process of collecting the optical communication signal at the plurality of focal positions using the condenser lens, the light reception process of receiving the collected optical communication signal by the light receiving means in which the plurality of light receiving sensors are arrayed, and the acquisition process of processing the sensor signals from the light receiving sensors to acquire the one or more communication signals. Therefore, according to the optical communication signal receiving method S1, it is possible to obtain an effect that the optical signal can be acquired even when focal position misalignment occurs in a light receiving device in which the plurality of light receiving sensors are arrayed.

### Second Exemplary Example Embodiment

A second exemplary example embodiment that is an example of the example embodiments of the present invention will be described in detail with reference to the drawings. Components that have the same functions as the components described in the above-described exemplary example embodiment are denoted by the same reference signs, and will not be described as appropriate. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in each of the drawings referred to for describing the present exemplary example embodiment can be adopted in the other exemplary example embodiments included in the present disclosure within a range in which no particular technical problem occurs.

### (Configuration of Optical Communication Signal Receiving Device 1A)

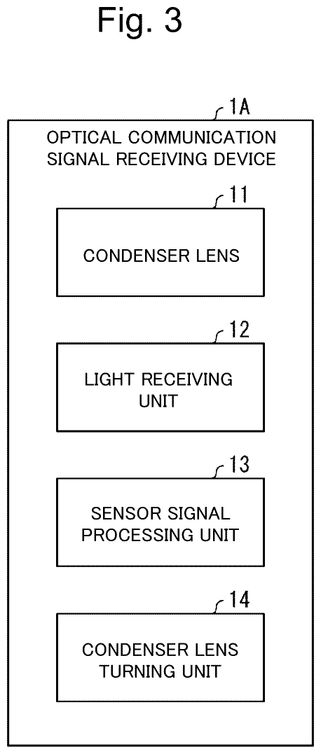

A configuration of a receiving device 1A will be described with reference to FIG. 3. FIG. 3 is a block diagram illustrating a configuration of the receiving device 1A. The receiving device 1A includes a condenser lens turning unit (condenser lens turning means) 14 in addition to the condenser lens 11, the light receiving unit 12, and the sensor signal processing unit 13 included in the receiving device 1.

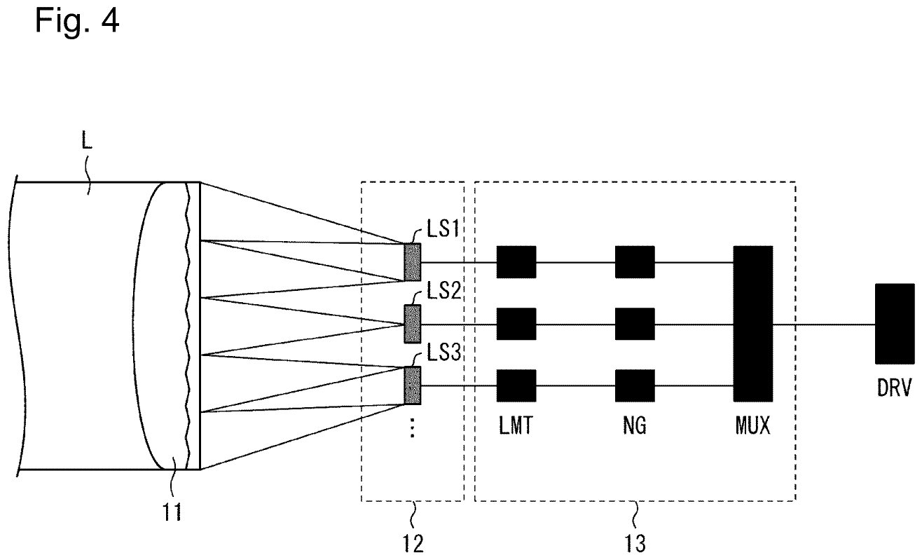

FIG. 4 is a schematic diagram illustrating specific configurations of the condenser lens 11, the light receiving unit 12, and the sensor signal processing unit 13. As illustrated in the drawing, a plurality of microlenses are formed in the condenser lens 11, and an optical signal L received by each of the microlenses is collected at a focal position. The microlenses are formed in such a way that the focal positions are arranged at equal intervals in a planar manner, for example. As described later, the condenser lens 11 is configured in such a way that the focal positions are slightly shifted from arrayed positions of light receiving sensors LS.

In the light receiving unit 12, n light receiving sensors LS1 to LSn (hereinafter, collectively referred to as “light receiving sensors LS”) that receive the collected optical signals L are arrayed. The light receiving sensors LS are arranged at equal intervals in a planar manner, for example. Further, the light receiving sensors LS are arrayed in such a way as to be slightly shifted from the focal positions. The light receiving sensors LS are, for example, photodiodes. The relationship between positions where the optical signal L is collected and positions where the light receiving sensors LS are arrayed will be described later.

As illustrated in the drawing, the sensor signal processing unit 13 includes, for example, LMT, NG, and MUX. LMT represents a limiter or a limiter amplifier that adjusts an output signal intensity from the light receiving sensor LS to be an appropriate value for a device (DRV or the like) at a subsequent stage. NG represents a noise gate that cuts a signal output when the signal intensity does not reach an appropriate value. MUX represents a multiplexer that combines input signals and outputs the combined signal. The output from the sensor signal processing unit 13 is sent to DRV. DRV represents a driver IC that extracts bit information from a sensor signal.

The condenser lens turning unit 14 performs turning using an actuator in such a way as to change a direction of a light receiving device including the condenser lens 11 and the light receiving unit 12. That is, the condenser lens turning unit 14 is a driving device that changes a direction of receiving the optical signal L. A specific method of use will be described later.

### (Specific Example of Light Receiving Unit 12)

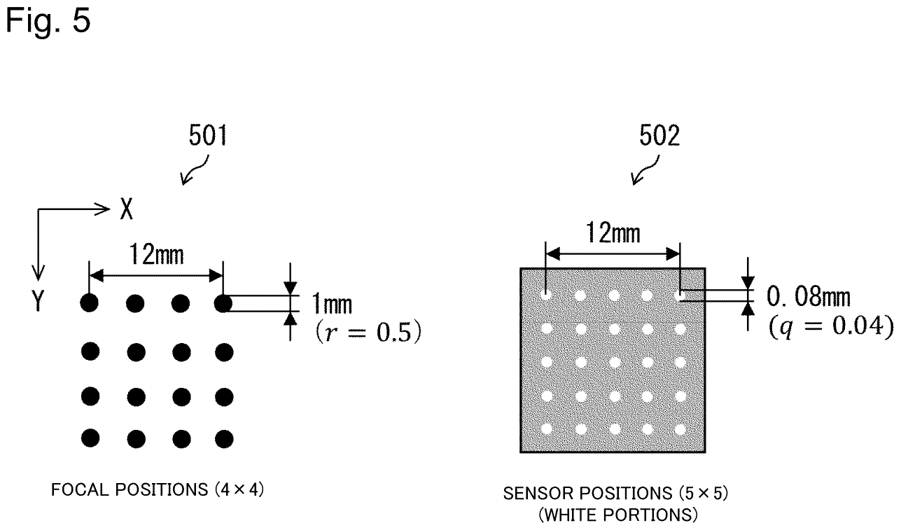

Next, the relationship between the positions where the optical signal L is collected and the positions where the light receiving sensors LS are arrayed in the light receiving unit 12 will be described. FIG. 5 is a schematic view illustrating sizes and arrangements of focal spots and the light receiving sensors LS. In FIG. 5, 501 is a schematic view illustrating the size and the arrangement of the focal spots (focal region), and the focal spots are illustrated in black circles. In the illustrated example, 4×4 (=16) focal spots are arranged at equal intervals in XY directions. A diameter of the focal spot is 1 mm, and a distance between center points of two adjacent focal spots is 4 mm.

In FIG. 5, 502 is a schematic view illustrating the size (a region where light can be effectively detected) and the arrangement of the light receiving sensors LS. In the illustrated example, the size and positions of the light receiving sensors LS are illustrated in white, and 5×5 (=25) light receiving sensors LS are arranged at equal intervals in the XY directions. A diameter of the light receiving sensor LS is 0.08 mm, and a distance between center points of two adjacent light receiving sensors LS is 3 mm.

As can be seen from FIG. 5, the focal positions and the light receiving sensors LS are two-dimensionally arranged at equal intervals. Further, the distance between center points of two adjacent focal positions is different from the distance between center points of two adjacent light receiving sensors LS. With such an array of the light receiving sensors LS, at least one of a plurality of collected optical communication signals can be received by at least one of the plurality of light receiving sensors LS.

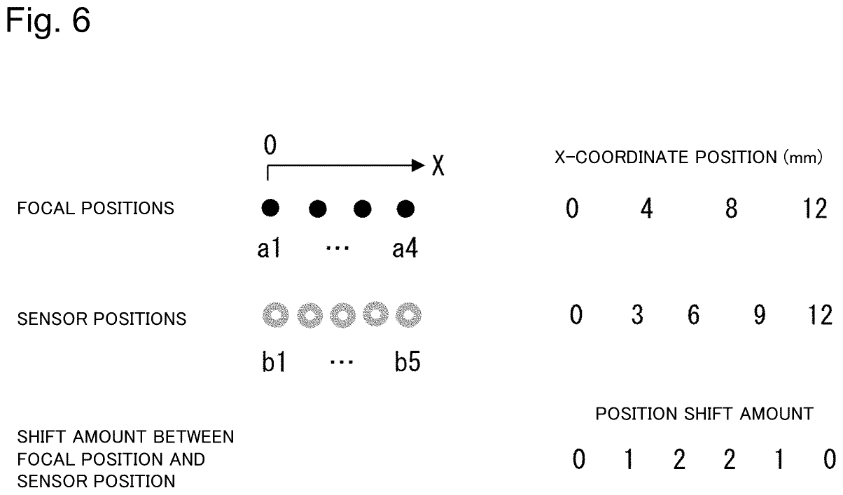

FIG. 6 is a schematic view illustrating a positional relationship between the focal spot and the light receiving sensor LS in the X direction. The focal spots are denoted by a1, a2, a3, and a4 in the X direction. The light receiving sensors LS are denoted by b1, b2, b3, b4, and b5 in the X direction. X-coordinate positions of center points of a1 to a4 are 0, 4, 8, and 12 (mm) in order, and X-coordinate positions of center points of b1 to b5 are 0, 3, 6, 9, and 12 (mm) in order. Here, position shift amounts (absolute values) from the center points of the positions b of the light receiving sensors LS as viewed from each of the center points of the focal spots a are sequentially 0, 1, 2, 2, 1, and 0 (the unit is omitted). Specifically, the shift amount between a1 and b1 is 0, the shift amount between a2 and b2 is 1, the shift amount between a2 and b3 is 2, the shift amount between a3 and b3 is 2, the shift amount between a3 and b4 is 1, and the shift amount between a4 and b5 is 0. That is, the shift amount from the position b of the light receiving sensor LS closest to the focal spot a is 1 (mm) or less. As described above, when the smallest shift amount between the focal spot a and the sensor position b is smaller than the sum of the diameter (1 mm) of the focal spot and the diameter (0.08 mm) of the light receiving sensor LS, any of the focal spots is always detected by any of the light receiving sensors LS.

That is, the focal positions and the light receiving sensors LS are arrayed in such a way that the minimum distance between a center point of a focal position and a center point of a light receiving sensor adjacent to the focal position is smaller than the sum of a focus diameter of an optical communication signal and a diameter of the light receiving sensor. The reason for this array is that if the plurality of focal positions and the plurality of light receiving sensors LS are designed to theoretically overlap at all positions, there is a possibility that all the positions of the focal spots are different from the positions of the light receiving sensors LS when misalignment occurs in the positional relationship between them due to a manufacturing error or the like, or when a focusing direction does not coincide with an optical axis of the condenser lens. The above-described configuration is a configuration for preventing such a situation.

Conditional expressions for enabling any one of the light receiving sensors LS to receive the optical signal even when the positions of the focal spots and the positions of the light receiving sensors LS are misaligned can be expressed as follows. The following conditional expressions (1) to (4) are conditional expressions in the X direction.

$$\begin{matrix}[ Math . 1 ] & \\ A ∈ a ( ∀ i , h ) a ( i , h ) = ih i = 0 , 1 , 2 , … , n & ( 1 )\end{matrix}$$

Here, A represents a set of focal spot coordinates in the X direction, a(i,h) represents the focal spot coordinates (coordinates in the X direction), n represents the number of focal spots, and h represents a distance between center points of adjacent focal spots.

$$\begin{matrix}[ Math . 2 ] & \\ B ∈ b ( ∀ j , k ) b ( j , k ) = jk j = 0 , 1 , 2 , … , m & ( 2 )\end{matrix}$$

Here, B represents a set of light receiving sensor coordinates in the X direction, b(j,k) represents the light receiving sensor coordinates (coordinates in the X direction), m represents the number of light receiving sensors, and k represents a distance between center points of adjacent light receiving sensors.

$$\begin{matrix}[ Math . 3 ] & \\ G ∈ g ( ∀ i , h , ∀ j , k ) g = \vert a ( i , h ) - b ( j , k ) \vert & ( 3 )\end{matrix}$$

Here, g represents the distance between center points of the focal spot and the light receiving sensor, and Expression (3) is an expression representing a shift amount.

$$\begin{matrix}[ Math . 4 ] & \\ ∃ g < r + q p = 1 & ( 4 )\end{matrix}$$

Here, r represents a diameter of the focal spot, q represents a diameter of the light receiving sensor, and Expression (4) represents a condition for enabling any one of the light receiving sensors can receive the optical signal. Further, p=1 is a flag indicating that light has been received.

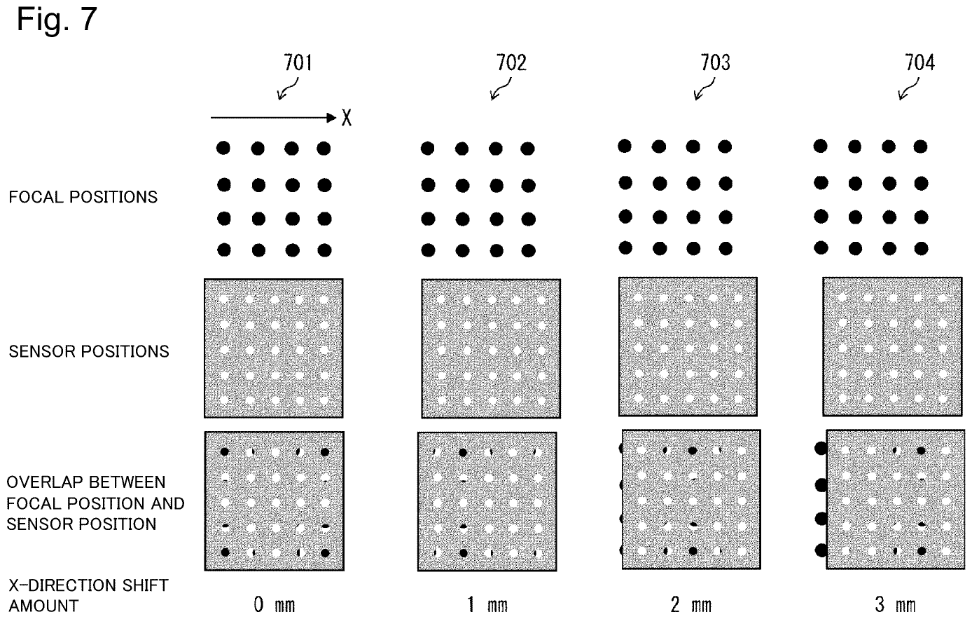

FIG. 7 is a schematic view illustrating a degree of overlap between the focal position and the light receiving sensor LS in a case where the optical axis of the condenser lens 11 is shifted from the light receiving unit 12 in the X direction when the focal spots illustrated in FIG. 5 are detected by the light receiving sensors LS. A black circle overlapping with a white sensor position indicates an overlapping portion therebetween. In FIG. 7, 701 illustrates overlap between the focal position and the light receiving sensor LS in a case where the shift amount in the X direction between the focal position and the light receiving sensor LS is 0 mm, that is, in a case where the position of a1 and the position of b1 illustrated in FIG. 6 coincide with each other. In the example illustrated in 701, both the focal position and the light receiving sensor LS completely overlap at positions at which x-direction distances are 0 mm and 12 mm, that is, the positions of the light receiving sensors b1 and b5. This means that the light receiving sensors b1 and b5 can receive the optical signal. Similarly, 702 in FIG. 7 illustrates a case where the shift amount is 1 mm, and both the focal position and the light receiving sensor LS completely overlap at the position of the light receiving sensor b2. In FIG. 7, 703 illustrates a case where the shift amount is 2 mm, and both the focal position and the light receiving sensor LS completely overlap at the position of the light receiving sensor b3. In FIG. 7, 704 illustrates a case where the shift amount is 3 mm, and both the focal position and the light receiving sensor LS completely overlap at the position of the light receiving sensor b4. Even if the shift amount includes a decimal point, any of the focal spots at least partially overlaps at a position of any of the light receiving sensors.

As described above, in the optical communication signal receiving device 1A, the light receiving sensors are arrayed in such a way that at least one of the plurality of collected optical communication signals can be received by at least one of the plurality of light receiving sensors with reference to a focus radius of the optical communication signal and the distance between the center points of two adjacent focal positions in consideration of positional misalignment between an optical axis direction of the condenser lens 11 and a light receiving direction of the optical communication signal. With such a configuration, even if the positional misalignment occurs between the focal positions and the light receiving sensors LS, any one of the light receiving sensors LS can always receive the optical signal.

Conversely, the sensor signal processing unit 13 can detect positional misalignment between a position of the optical axis of the condenser lens 11 and a position of the light receiving unit 12 based on a reception pattern indicating which light receiving sensor among the plurality of light receiving sensors LS has received the optical signal. This is because the position of the light receiving sensor that receives the optical signal is determined by the magnitude of the positional misalignment as described with reference to FIG. 7.

The above relationship can be easily obtained by making the least common multiple of the interval between adjacent focal positions and the interval between adjacent light receiving sensors correspond to an array width of the focal positions and an array width of the light receiving sensors. That is, it is possible to easily design the condenser lens 11 and the light receiving unit 12 capable of acquiring the optical signal even when focal position misalignment occurs in the light receiving device in which the plurality of light receiving sensors are arrayed.

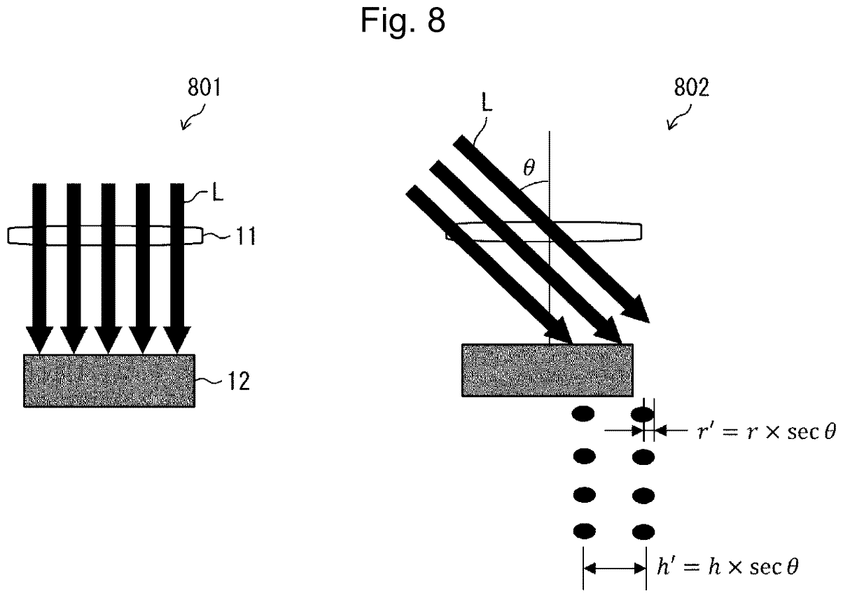

Next, a case where an incident direction of the optical signal L deviates from the optical axis direction of the condenser lens 11 will be described. FIG. 8 is a schematic view illustrating the incident direction of the optical signal L in a state (illustrated in 801) of being along the optical axis direction of the condenser lens 11 and in a state (illustrated in 802) of deviating by an angle θ.

As illustrated in 802 of FIG. 8, when the incident direction of the optical signal L deviates by θ from the optical axis direction of the condenser lens 11, the shape of the focal spot is elliptical. A diameter r′ of the elliptical shape in the longitudinal direction is expressed by the following expression.

$${r}^{′} = r \times sec θ , where sec θ = 1 / cos θ .$$

In addition, a distance h′ between center points of adjacent focal spots is expressed by the following expression.

$${h}^{′} = h \times sec θ$$

In this case, conditional expressions for enabling any one of the light receiving sensors LS to receive the optical signal can be expressed as the following Expressions (5) to (8). The conditional expressions are conditional expressions in the X direction. Reference signs other than r′ and h′ are the same as those in Expressions (1) to (4).

$$\begin{matrix}[ Math . 5 ] & \\ A ∈ a ( ∀ i , {h}^{′} ) a ( i , {h}^{′} ) = {ih}^{′} i = 0 , 1 , 2 , … , n & ( 5 )\end{matrix}$$

$$\begin{matrix}[ Math . 6 ] & \\ B ∈ b ( ∀ j , k ) b ( j , k ) = jk j = 0 , 1 , 2 , … , m & ( 6 )\end{matrix}$$

$$\begin{matrix}[ Math . 7 ] & \\ G ∈ g ( ∀ i , {h}^{′} , ∀ j , k ) g = \vert a ( i , {h}^{′} ) - b ( j , k ) \vert & ( 7 )\end{matrix}$$

$$\begin{matrix}[ Math . 8 ] & \\ ∃ g < {r}^{′} + q p = 1 & ( 8 )\end{matrix}$$

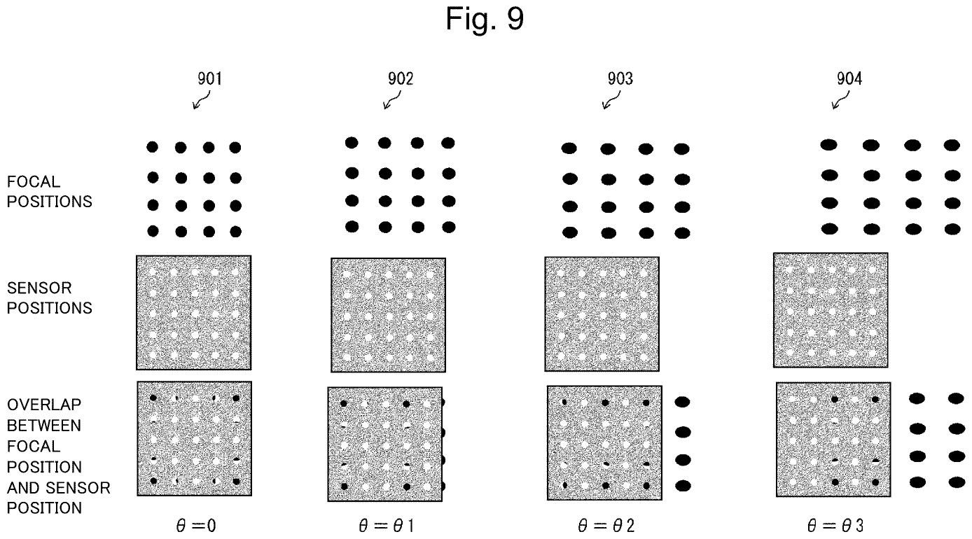

FIG. 9 is a schematic view illustrating an overlapping state in a case where the incident direction of the optical signal L deviates from the optical axis direction of the condenser lens 11. In FIG. 9, 901 is a schematic view illustrating an overlapping state in a case where the incident direction of the optical signal L is the same as the optical axis direction of the condenser lens (θ=0). In FIG. 9, 902 to 904 illustrate a case where the incident direction of the optical signal L deviates from the optical axis direction of the condenser lens, and illustrate a state in which the position and shape of the focal spot greatly change as the deviation angle θ increases. Even in such a case, any of the focal spots always at least partially overlaps with the light receiving sensor LS. Parameters of n, m, h, k, r, and q can be set in such a way that any of the focal spots always overlaps with the light receiving sensor LS within the assumed range of 0.

Note that, as a conditional expression for enabling light reception in a case where an angular deviation occurs, assuming that the focal spot moves by f due to the angular deviation, a conditional expression in which the right side of Expression (4) is modified to r+q+f and the left side thereof is modified to f or more may be used. When the parameters are set in such a way as to satisfy the modified expression of Expression (4) with respect to the assumed f, any of the focal spots can be always received by any of the light receiving sensors LS even when the angular deviation occurs.

In addition, the sensor signal processing unit 13 can detect the angular deviation (θ) between the optical axis direction of the condenser lens 11 and the light receiving direction of the optical communication signal L based on the reception pattern indicating which light receiving sensor among the plurality of light receiving sensors LS has received the optical communication signal. As illustrated in FIG. 9, positions of the light receiving sensors LS capable of receiving light and the amount of received light vary depending on the angle θ. Therefore, conversely, the deviation angle is obtained from the positions of the light receiving sensors LS that have received light and the amount of received light. For example, an angle conversion formula or the reception pattern is created by transmitting an optical signal to the light receiving sensors LS at the angle θ from various directions and measuring positions of the light receiving sensors having received the optical signal and the amount of received light. Then, when an optical signal is actually received, a direction and an angle thereof may be obtained using the conversion formula or the reception pattern.

### (Condenser Lens Turning Unit 14)

The condenser lens turning unit 14 changes the optical axis direction of the condenser lens in such a way as to eliminate the angular deviation between the optical axis direction of the condenser lens and the light receiving direction of the optical communication signal. That is, the condenser lens turning unit 14 refers to the light receiving direction and the angle θ of the optical signal L derived by the sensor signal processing unit 13, and changes the optical axis direction of the condenser lens in such a way that the angle θ becomes zero. The condenser lens turning unit 14 may be driven and controlled by a condenser lens turning program. With such a configuration, the receiving device 1A can correct the light receiving direction in such a way as to receive the optical signal along the optical axis direction.

### (Effect of Optical Communication Signal Receiving Device)

As described above, the optical communication signal receiving device 1A adopts a configuration in which the focal positions and the light receiving sensors are arrayed at equal intervals, respectively, in such a way that the distance between the center points of two adjacent focal positions is different from the distance between the center points of two adjacent light receiving sensors, and the light receiving sensors are arrayed in such a way that at least one of the plurality of collected optical communication signals can be received by at least one of the plurality of light receiving sensors. Therefore, according to the optical communication signal receiving device 1A, it is possible to obtain an effect that the optical signal can be acquired even when focal position misalignment occurs in a light receiving device in which the plurality of light receiving sensors are arrayed.

In addition, the optical communication signal receiving device 1A adopts a configuration in which the focal positions and the light receiving sensors LS are arrayed in such a way that the minimum distance between a center point of a focal position and a center point of a light receiving sensor adjacent to the focal position is smaller than the sum of a focus diameter of an optical communication signal and a diameter of the light receiving sensor. Therefore, according to the optical communication signal receiving device 1A, it is possible to acquire the optical signal even when the focal position misalignment occurs in the light receiving device in which the plurality of light receiving sensors are arrayed, and further, it is possible to obtain an effect that such a configuration can be theoretically designed.

In addition, the optical communication signal receiving device 1A adopts a configuration in which the sensor signal processing unit 13 detects the angular deviation between the optical axis direction of the condenser lens and the light receiving direction of the optical communication signal based on the reception pattern indicating which light receiving sensor among the plurality of light receiving sensors has received the optical communication signal. Therefore, according to the optical communication signal receiving device 1A, in addition to the effect obtained by the optical communication signal receiving device 1, it is possible to detect the angular deviation between the optical axis direction of the condenser lens and the light receiving direction of the optical communication signal and correct the angular deviation.

In addition, the optical communication signal receiving device 1A adopts a configuration in which the sensor signal processing unit 13 detects the positional misalignment between the position of the optical axis of the condenser lens and a position of a light receiving means based on the reception pattern indicating which light receiving sensor among the plurality of light receiving sensors has received the optical communication signal. Therefore, according to the optical communication signal receiving device 1A, in addition to the effect obtained by the optical communication signal receiving device 1, it is possible to obtain an effect that the positional misalignment can be corrected as necessary.

In addition, the optical communication signal receiving device 1A adopts a configuration in which the light receiving sensors are arrayed in such a way that at least one of the plurality of collected optical communication signals can be received by at least one of the plurality of light receiving sensors with reference to the focus radius of the optical communication signal and the distance between the center points of two adjacent focal positions in consideration of the positional misalignment between the optical axis direction of the condenser lens 11 and the light receiving direction of the optical communication signal. Therefore, according to the optical communication signal receiving device 1A, an effect similar to the effect obtained by the optical communication signal receiving device 1 can be obtained.

In addition, the optical communication signal receiving device 1A further includes the condenser lens turning means that changes the optical axis direction of the condenser lens in such a way as to eliminate the angular deviation between the optical axis direction of the condenser lens and the light receiving direction of the optical communication signal. Therefore, according to the optical communication signal receiving device 1A, in addition to the effect obtained by the optical communication signal receiving device 1, it is possible to obtain an effect that the angular deviation between the optical axis direction of the condenser lens and the light receiving direction of the optical communication signal can be eliminated.

In addition, the optical communication signal receiving device 1A adopts a configuration in which the least common multiple of the interval between adjacent focal positions and the interval between adjacent light receiving sensors corresponds to the array width of the focal positions and the array width of the light receiving sensors. Therefore, according to the optical communication signal receiving device 1A, in addition to the effect obtained by the optical communication signal receiving device 1, it is possible to easily design a configuration capable of acquiring the optical signal even when the focal position misalignment occurs in the light receiving device in which the plurality of light receiving sensors are arrayed.

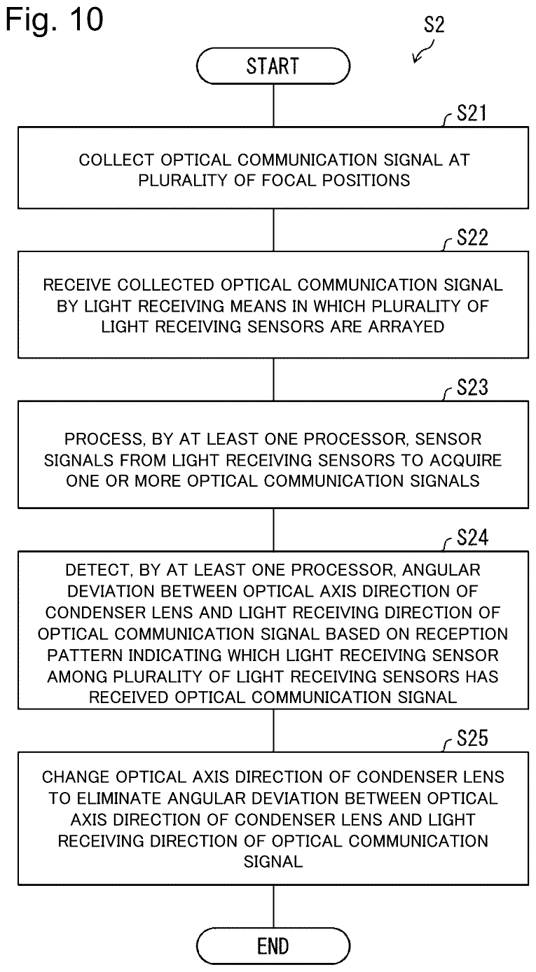

Next, an optical communication signal receiving method S2 according to the present exemplary example embodiment will be described. FIG. 10 is a flowchart illustrating a flow of the optical communication signal receiving method S2. As illustrated in the drawing, the optical communication signal receiving method S2 includes steps S21 to S25. Since steps S21 to S23 are the same as the optical communication signal receiving method S1 described in the first exemplary example embodiment, the description thereof is omitted here.

Step S24 is a detection step of detecting an angular deviation between an optical axis direction of a condenser lens and a light receiving direction of an optical communication signal based on a reception pattern indicating which light receiving sensor among a plurality of the light receiving sensors has received the optical communication signal. The detection step may be executed by the sensor signal processing unit 13 (processor).

Step S25 is a change step of changing the optical axis direction of the condenser lens in such a way as to eliminate the angular deviation between the optical axis direction of the condenser lens and the light receiving direction of the optical communication signal. The change step may be executed by the condenser lens turning unit 14 according to a control program.

According to the optical communication signal receiving method S2 including the above steps, in addition to the effect obtained by the optical communication signal receiving method S1, a light receiving direction of each of the optical communication signal receiving devices 1 and 1A can be mechanically set (changed) to a desired direction.

### Example of Implementation by Software

Some functions of the optical communication signal receiving devices 1 and 1A (hereinafter, also referred to as “each of the above devices”) may be implemented by hardware such as an integrated circuit (an IC chip) or may be implemented by software.

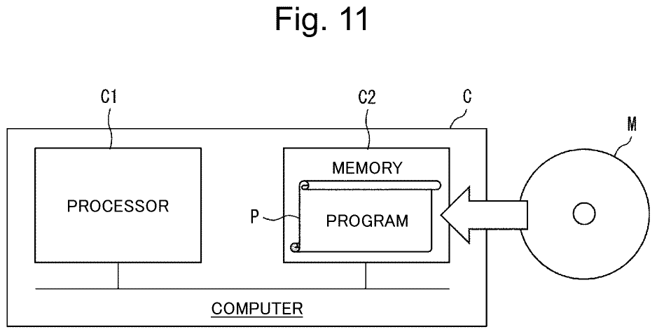

In the latter case, each of the above devices is implemented by, for example, a computer that executes commands of a program, that is software for implementing each function. An example of such a computer (hereinafter, referred to as a computer C) is illustrated in FIG. 11. FIG. 11 is a block diagram illustrating a hardware configuration of the computer C functioning as each of the above devices.

The computer C includes at least one processor C1 and at least one memory C2. A program P for causing the computer C to operate as each of the above devices is recorded in the memory C2. In the computer C, the processor C1 reads the program P from the memory C2 and executes the program P to implement each function of each of the above devices.

Available examples of the processor C1 include a central processing unit (CPU), a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, and a combination thereof. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. In addition, the computer C may further include a communication interface for transmitting and receiving data to and from another device. The computer C may further include an input/output interface for connecting input/output devices such as a keyboard, a mouse, a display, or a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. In addition, the program P can be transmitted via a transmission medium. As such a transmission medium, for example, a communication network, a broadcast wave, or the like can be used. The computer C can also acquire the program P via such a transmission medium.

Each of the above functions of each of the above devices may be implemented by a single processor provided in a single computer, may be implemented in cooperation with a plurality of processors provided in a single computer, or may be implemented in cooperation with a plurality of processors provided in each of a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information 1

The present disclosure includes the technologies described in the following Supplementary Notes. However, the present invention is not limited to the technologies described in the following Supplementary Notes, and various modifications can be made within the scope described in the claims.

### (Supplementary Note 1)

An optical communication signal receiving device including:
a condenser lens that collects an optical communication signal at a plurality of focal positions;
a light receiving means in which a plurality of light receiving sensors are arrayed to receive the optical communication signal collected at the focal positions; and
a sensor signal processing means for processing sensor signals from the light receiving sensors to acquire one or more optical communication signals.

### (Supplementary Note 2)

The optical communication signal receiving device according to Supplementary Note 1, wherein
the focal positions and the light receiving sensors are arrayed at equal intervals, respectively, in such a way that a distance between center points of two of the focal positions adjacent to each other is different from a distance between center points of two of the light receiving sensors adjacent to each other, and
the light receiving sensors are arrayed in such a way as to enable at least one of the plurality of light receiving sensors to receive at least one of a plurality of the collected optical communication signals.

### (Supplementary Note 3)

The optical communication signal receiving device according to Supplementary Note 1 or 2, wherein the focal positions and the light receiving sensors are arrayed in such a way that the minimum distance between a center point of one of the focal positions and a center point of the light receiving sensor adjacent to the one of the focal positions is smaller than a sum of a focus diameter of the optical communication signal and a diameter of each of the light receiving sensors.

### (Supplementary Note 4)

The optical communication signal receiving device according to any one of Supplementary Notes 1 to 3, wherein the sensor signal processing means detects an angular deviation between an optical axis direction of the condenser lens and a light receiving direction of the optical communication signal based on a reception pattern indicating which light receiving sensor among the plurality of light receiving sensors has received the optical communication signal.

### (Supplementary Note 5)

The optical communication signal receiving device according to any one of Supplementary Notes 1 to 4, wherein the sensor signal processing means detects positional misalignment between a position of an optical axis of the condenser lens and a position of the light receiving means based on a reception pattern indicating which light receiving sensor among the plurality of light receiving sensors has received the optical communication signal.

### (Supplementary Note 6)

The optical communication signal receiving device according to any one of Supplementary Notes 1 to 5, wherein the light receiving sensors are arrayed in such a way as to enable at least one of the plurality of light receiving sensors to receive at least one of a plurality of the collected optical communication signals with reference to a focus radius of the optical communication signal and a distance between center points of two of the focal positions adjacent to each other in consideration of positional misalignment between an optical axis direction of the condenser lens and a light receiving direction of the optical communication signal.

### (Supplementary Note 7)

The optical communication signal receiving device according to Supplementary Note 4, further including a condenser lens turning means for changing the optical axis direction of the condenser lens in such a way as to eliminate the angular deviation between the optical axis direction of the condenser lens and the light receiving direction of the optical communication signal.

### (Supplementary Note 8)

The optical communication signal receiving device according to any one of Supplementary Notes 1 to 7, wherein the least common multiple of an interval between the focal positions adjacent to each other and an interval between the light receiving sensors adjacent to each other corresponds to an array width of the focal positions and an array width of the light receiving sensors.

### (Supplementary Note 9)

An optical communication signal receiving method including:
collecting an optical communication signal at a plurality of focal positions using a condenser lens;
receiving the collected optical communication signal by a light receiving means in which a plurality of light receiving sensors are arrayed; and
processing sensor signals from the light receiving sensors to acquire one or more optical communication signals.

### (Supplementary Note 10)

The optical communication signal receiving method according to Supplementary Note 9, further including:
detecting an angular deviation between an optical axis direction of the condenser lens and a light receiving direction of the optical communication signal based on a reception pattern indicating which light receiving sensor among the plurality of light receiving sensors has received the optical communication signal; and
changing the optical axis direction of the condenser lens in such a way as to eliminate the angular deviation between the optical axis direction of the condenser lens and the light receiving direction of the optical communication signal.

### (Supplementary Note 11)

The optical communication signal receiving method according to Supplementary Note 9 or 10, wherein the focal positions of the condenser lens and the light receiving sensors are arrayed at equal intervals, respectively, in such a way that a distance between center points of two of the focal positions adjacent to each other is different from a distance between center points of two of the light receiving sensors adjacent to each other, and
the light receiving sensors are arrayed in such a way as to enable at least one of the plurality of light receiving sensors to receive at least one of a plurality of the collected optical communication signals.

### (Supplementary Note 12)

The optical communication signal receiving method according to Supplementary Note 11, wherein the focal positions and the light receiving sensors are arrayed in such a way that the minimum distance between a center point of one of the focal positions and a center point of the light receiving sensor adjacent to the one of the focal positions is smaller than a sum of a focus diameter of the optical communication signal and a diameter of each of the light receiving sensors.

### (Supplementary Note 13)

The optical communication signal receiving method according to Supplementary Note 11 or 12, further including detecting an angular deviation between an optical axis direction of the condenser lens and a light receiving direction of the optical communication signal based on a reception pattern indicating which light receiving sensor among the plurality of light receiving sensors has received the optical communication signal.

### (Supplementary Note 14)

The optical communication signal receiving method according to any one of Supplementary Notes 11 to 13, further including detecting positional misalignment between a position of an optical axis of the condenser lens and a position of the light receiving means based on a reception pattern indicating which light receiving sensor among the plurality of light receiving sensors has received the optical communication signal.

### (Supplementary Note 15)

The optical communication signal receiving method according to any one of Supplementary Notes 11 to 14, wherein the light receiving sensors are arrayed in such a way as to enable at least one of the plurality of light receiving sensors to receive at least one of a plurality of the collected optical communication signals with reference to a focus radius of the optical communication signal and a distance between center points of two of the focal positions adjacent to each other in consideration of positional misalignment between an optical axis direction of the condenser lens and a light receiving direction of the optical communication signal.

### (Supplementary Note 16)

The optical communication signal receiving method according to Supplementary Note 13, further including changing the optical axis direction of the condenser lens in such a way as to eliminate the angular deviation between the optical axis direction of the condenser lens and the light receiving direction of the optical communication signal.

### (Supplementary Note 17)

The optical communication signal receiving method according to any one of Supplementary Notes 11 to 16, wherein the least common multiple of an interval between the focal positions adjacent to each other and an interval between the light receiving sensors adjacent to each other corresponds to an array width of the focal positions and an array width of the light receiving sensors.

### Supplementary Information 2

The present disclosure includes the technologies described in the following Supplementary Notes. However, the present invention is not limited to the technologies described in the following Supplementary Notes, and various modifications can be made within the scope described in the claims.

### (Supplementary Note 21)

An optical communication signal receiving device including:
a condenser lens that collects an optical communication signal at a plurality of focal positions;
a light receiving means in which a plurality of light receiving sensors are arrayed to receive the optical communication signal collected at the focal positions; and
at least one processor,
wherein the processor executes sensor signal processing of processing sensor signals from the light receiving sensors to acquire one or more optical communication signals.

The optical communication signal receiving device may further include a memory. The memory may store a program for causing the processor to execute the sensor signal processing.

### (Supplementary Note 22)

The optical communication signal receiving device according to Supplementary Note 21, wherein
the focal positions and the light receiving sensors are arrayed at equal intervals, respectively, in such a way that a distance between center points of two of the focal positions adjacent to each other is different from a distance between center points of two of the light receiving sensors adjacent to each other, and
the light receiving sensors are arrayed in such a way as to enable at least one of the plurality of light receiving sensors to receive at least one of a plurality of the collected optical communication signals.

### (Supplementary Note 23)

The optical communication signal receiving device according to Supplementary Note 22, wherein the focal positions and the light receiving sensors are arrayed in such a way that the minimum distance between a center point of one of the focal positions and a center point of the light receiving sensor adjacent to the one of the focal positions is smaller than a sum of a focus diameter of the optical communication signal and a diameter of each of the light receiving sensors.

### (Supplementary Note 24)

The optical communication signal receiving device according to Supplementary Note 22, wherein the processor detects an angular deviation between an optical axis direction of the condenser lens and a light receiving direction of the optical communication signal based on a reception pattern indicating which light receiving sensor among the plurality of light receiving sensors has received the optical communication signal.

### (Supplementary Note 25)

The optical communication signal receiving device according to Supplementary Note 22, wherein the processor detects positional misalignment between a position of an optical axis of the condenser lens and a position of the light receiving means based on a reception pattern indicating which light receiving sensor among the plurality of light receiving sensors has received the optical communication signal.

### (Supplementary Note 26)

The optical communication signal receiving device according to Supplementary Note 22, wherein the light receiving sensors are arrayed in such a way as to enable at least one of the plurality of light receiving sensors to receive at least one of a plurality of the collected optical communication signals with reference to a focus radius of the optical communication signal and a distance between center points of two of the focal positions adjacent to each other in consideration of positional misalignment between an optical axis direction of the condenser lens and a light receiving direction of the optical communication signal.

### (Supplementary Note 27)

The optical communication signal receiving device according to Supplementary Note 24, wherein the processor further executes condenser lens turning processing of changing the optical axis direction of the condenser lens in such a way as to eliminate the angular deviation between the optical axis direction of the condenser lens and the light receiving direction of the optical communication signal.

### (Supplementary Note 28)

The optical communication signal receiving device according to Supplementary Note 22, wherein the least common multiple of an interval between the focal positions adjacent to each other and an interval between the light receiving sensors adjacent to each other corresponds to an array width of the focal positions and an array width of the light receiving sensors.

### (Supplementary Note 29)

An optical communication signal receiving method including:
collecting an optical communication signal at a plurality of focal positions using a condenser lens;
receiving the collected optical communication signal by a light receiving means in which a plurality of light receiving sensors are arrayed; and
processing, by at least one processor, sensor signals from the light receiving sensors to acquire one or more optical communication signals.

### (Supplementary Note 30)

The optical communication signal receiving method according to Supplementary Note 29, further including:
detecting, by the processor, an angular deviation between an optical axis direction of the condenser lens and a light receiving direction of the optical communication signal based on a reception pattern indicating which light receiving sensor among the plurality of light receiving sensors has received the optical communication signal; and
changing, by the processor, the optical axis direction of the condenser lens in such a way as to eliminate the angular deviation between the optical axis direction of the condenser lens and the light receiving direction of the optical communication signal.

1. An optical communication signal receiving device comprising:
a condenser lens that collects an optical communication signal at a plurality of focal positions;
a light receiver in which a plurality of light receiving sensors are arrayed to receive the optical communication signal collected at the focal positions;
one or more memories storing instructions; and
one or more processors configured to execute the instructions to process sensor signals from the light receiving sensors to acquire one or more optical communication signals.

2. The optical communication signal receiving device according to claim 1, wherein
the focal positions and the light receiving sensors are arrayed at equal intervals, respectively, in such a way that a distance between center points of two of the focal positions adjacent to each other is different from a distance between center points of two of the light receiving sensors adjacent to each other, and
the light receiving sensors are arrayed in such a way as to enable at least one of the plurality of light receiving sensors to receive at least one of a plurality of the collected optical communication signals.

3. The optical communication signal receiving device according to claim 1, wherein the focal positions and the light receiving sensors are arrayed in such a way that a minimum distance between a center point of one of the focal positions and a center point of the light receiving sensor adjacent to the one of the focal positions is smaller than a sum of a focus diameter of the optical communication signal and a diameter of each of the light receiving sensors.

4. The optical communication signal receiving device according to claim 1, wherein the one or more processors detect an angular deviation between an optical axis direction of the condenser lens and a light receiving direction of the optical communication signal based on a reception pattern indicating which light receiving sensor among the plurality of light receiving sensors has received the optical communication signal.

5. The optical communication signal receiving device according to claim 1, wherein the one or more processors detect positional misalignment between a position of an optical axis of the condenser lens and a position of the light receiver based on a reception pattern indicating which light receiving sensor among the plurality of light receiving sensors has received the optical communication signal.

6. The optical communication signal receiving device according to claim 1, wherein the light receiving sensors are arrayed in such a way as to enable at least one of the plurality of light receiving sensors to receive at least one of a plurality of the collected optical communication signals with reference to a focus radius of the optical communication signal and a distance between center points of two of the focal positions adjacent to each other in consideration of positional misalignment between an optical axis direction of the condenser lens and a light receiving direction of the optical communication signal.

7. The optical communication signal receiving device according to claim 4, further comprising a condenser lens turning mechanism configured to change the optical axis direction of the condenser lens in such a way as to eliminate the angular deviation between the optical axis direction of the condenser lens and the light receiving direction of the optical communication signal.

8. The optical communication signal receiving device according to claim 1, wherein a least common multiple of an interval between the focal positions adjacent to each other and an interval between the light receiving sensors adjacent to each other corresponds to an array width of the focal positions and an array width of the light receiving sensors.

9. An optical communication signal receiving method comprising:
collecting an optical communication signal at a plurality of focal positions using a condenser lens;
receiving the collected optical communication signal by a light receiver in which a plurality of light receiving sensors are arrayed; and
processing sensor signals from the light receiving sensors to acquire one or more optical communication signals.

10. The optical communication signal receiving method according to claim 9, further comprising:
detecting an angular deviation between an optical axis direction of the condenser lens and a light receiving direction of the optical communication signal based on a reception pattern indicating which light receiving sensor among the plurality of light receiving sensors has received the optical communication signal; and
changing the optical axis direction of the condenser lens in such a way as to eliminate the angular deviation between the optical axis direction of the condenser lens and the light receiving direction of the optical communication signal.
